(19) United States
(12) Patent Application Publication
(10) Pub. No.: US 2017/0140444 A1
(43) Pub. Date: May 18, 2017

(54) SYSTEMS AND METHODS FOR MAINTAINING CONSISTENT PRICE PREMIUMS ACROSS PRODUCTS AND STORES

(71) Applicant: Clear Demand, Inc., Scottsdale, AZ (US)

(72) Inventors: James A. SILLS, Scottsdale, AZ (US); Alex E. BUDIN, Prescott, AZ (US); Adam N. ROSENBERG, Scottsdale, AZ (US)

(73) Assignee: Clear Demand, Inc., Scottsdale, AZ (US)

(21) Appl. No.: 15/341,861

(22) Filed: Nov. 2, 2016

Related U.S. Application Data
(60) Provisional application No. 62/285,514, filed on Nov. 2, 2015.

(51) Int. Cl. G06Q 30/02; G06F 17/18

(52) U.S. Cl. CPC G06Q 30/0283; G06F 17/18

(57) ABSTRACT

Disclosed are system and methods of recommending price premium values of products based on price zones and factors. Retail chains have stores in several price zones of varying demographics and price level. The systems and methods use the pattern of pricing in the price zones to identify outliers where the price of a product in a price zone is not consistent with other products priced in that price zone. The price zone premium values used in evaluating individual-product prices in a price zone are calculated locally for each subclass of products and those values may be aggregated into price zone premium values for the entire enterprise.

### CROSS-REFERENCE TO RELATED APPLICATION

This application claims the benefit of the filing date of U.S. Provisional Application Ser. No. 62/285,514 filed Nov. 2, 2015, the entire disclosure is incorporated herein by reference.

### TECHNICAL FIELD

The present technology pertains to retail pricing, and more specifically pertains to recommending prices premium values of products based on price zones and factors.

### BACKGROUND

Retail chains maintain prices for thousands of products in hundreds of price zones. Prices can be based on shopper demand (e.g., economic elasticity) and a variety of business rules (e.g., competitive-price positions, profit-margin requirements, brand and size relationships, specified relationships between similar products, etc.).

In addition to these economic and business requirements, price zones can have broad-sweeping price relationships to other price zones. Prices can be normalized from brand-to-brand and across sizes. In a similar fashion, price changes that fix price zone-to-price zone price anomalies can be recommended.

Managing prices can be a time consuming process. Category managers can have limited time to manage prices for all products across all price zones. Category managers generally focus on managing price for those products that have the highest revenues, leaving lower revenue products less managed. For example, there can be price differentiation across the price zones for a high revenue product, but not for a low revenue product. As such, the category manager will simply price the low revenue products the same across all price zones. Pricing the low revenue products the same across all price zones creates inefficiencies as the retailer could charge more for the products in some prices zones and should charge less for the product in other prices zones. A system and method for identifying price zone premiums that can be consistently followed for high revenue products and projecting those consistencies onto lower revenue products is needed. Accordingly, the category manager can continue to focus on the high revenue products, and the low revenue products are managed automatically through the systems and methods described.

### SUMMARY

Disclosed are systems, methods, and non-transitory computer-readable storage mediums for re-pricing products according to price premiums. The systems, methods, and non-transitory computer-readable mediums can include determining one or more prices of one or more products across one or more price zones, calculating price premiums between the one or more price zones for the one or more products, identifying, at the server, one or more unbalanced prices of the one or more products, and recommending one or more balanced prices for the one or more unbalanced prices of products.

The systems, methods, and non-transitory computer-readable mediums can also include determining for each of the one or more products a revenue-weighted average price over the one or more price zones.

The systems, methods, and non-transitory computer-readable mediums can also include determining a ratio for each of the one or more prices of each of the one or more products across each of the one or more price zones by dividing each price by the revenue-weighted average price of the product across price zones.

The systems, methods, and non-transitory computer-readable mediums can also include the price premiums are calculated by a least-fit square. In other examples, the price premiums are calculated for a subclass of the one or more products.

The systems, methods, and non-transitory computer-readable mediums can also include comparing each of the one or more prices of the one or more products across the one or more price zones with the price premiums, and when a price of the one or more prices is outside of a prescribed threshold of the price premiums, determining the product associated with the price is unbalanced.

The systems, methods, and non-transitory computer-readable mediums can also include that the one or more balanced prices increases (or decreases) an unbalanced price of the one or more products.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only example embodiments of the disclosure and are not therefore to be considered to be limiting of its scope, the principles herein are described and explained with additional specificity and detail through the use of the accompanying drawings in which:

FIG. 1A shows a graphical user interface of a heat map of an example of current prices of products and price zones;

FIG. 1B shows a graphical user interface of a heat map of an example of recommended prices of products and price zones;

FIG. 2 show a flow chart of an example method re-pricing products;

FIG. 3A shows a first example system embodiment for implementing various embodiments of the present technology; and

FIG. 3B shows a second example system embodiment for implementing various embodiments of the present technology.

### DETAILED DESCRIPTION

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Various examples of the disclosure are discussed in detail below. While specific implementations are discussed, it should be understood that this is done for illustration purposes only. The terms “e.g.” and “i.e.” are used to show specific examples for illustration and contextual purposes only and should not be considered limiting. As such, specific examples are not limiting, but merely provide a contextual basis for present disclosure. The present disclosure also includes the use of one or more of the examples, but not other ones of the examples. A person skilled in the relevant art will recognize that other components and configurations may be used without parting from the scope of the disclosure.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The term “comprising”, which is synonymous with “including,” “containing,” or “characterized by” is inclusive or open-ended and does not exclude additional, unrecited elements or method steps. “Comprising” is a term of art used in claim language which means that the named elements are present, but other elements can be added and still form a construct or method within the scope of the claim.

Disclosed are a plurality of prices for products in a plurality of price zones from a variety of sources or locations. There can be price-difference trends from the plurality of price zones, and as such, price premiums can be determined for each price zone. The prices that best-fit match the price premiums can be balanced prices. The best-fit match can be determined on a product-subclass basis or across the entire enterprise of products. When individual prices deviate further than a prescribed threshold, price changes can be recommended to align the prices to the corresponding price zone.

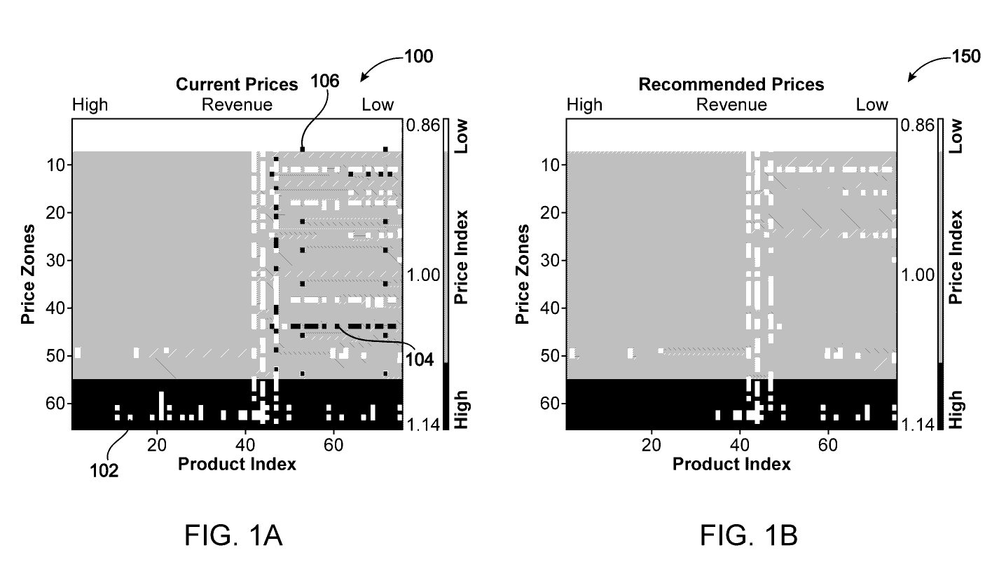

FIGS. 1A and 1B show current prices of products in price zones and recommended prices in price zones respectively. For ease of explanation, FIGS. 1A and 1B are shown as “heat maps” (e.g., 100, 150). While FIGS. 1A and 1B show strict division between the darker and lighter sections, this is merely for ease of explanation and not limiting. For example, there can be a more gradual change between dark and light colors (or vice versa), similar to that of a heat map. In some examples, the darker and light sections can be color. For example, blue can be equivalent to the darkest color and red to the lightest color (and yellow, orange, blue, etc. in between).

Referring now to FIG. 1A, the plurality of products can be arranged from high to low revenue (e.g., from left to right). The price zones can be arranged from high to low premium (e.g., bottom to top, black to light). For example, products in darker price zones are priced higher than products in lighter price zones. In some examples, white portions in any of the price zones can represent that there is no product currently being offered in that price zone. Each portion (or square) of heat map 100, can represent a product (e.g., 102, 104, 106) at a specific price. Each of the prices of products can be compared to an average price for the corresponding product in that price zone. For example, a product could be priced at $1.25, which is high for the corresponding price zone when the average price is $0.99. In another example, a product could be priced at $8.79, which is low for the corresponding price zone when the average price is $9.99.

Still referring to FIG. 1A, products (e.g., 102, 104, 106) can be shown across one or more price zones. The products (e.g., 102, 104, 106) can have inconsistent prices for the respective price zone (e.g., outliers). For example, inconsistent prices can be where a product in a price zone is higher (e.g., 104, 106) or lower (e.g., 102) than other products in the same price zone. Disclosed are systems and methods to re-price (or balance) products (e.g., 102, 104, 106) more consistently in price zones (e.g., 108, 110) as shown in FIG. 1B (e.g., fewer anomalous prices). In some examples, logarithm-based least-squares fit can be used to re-prices products. For example, by using big-revenue products to balance small-revenue products and tuning the pricing based on a demand model for creating a same-margin solution (e.g., where margin is equal to profit over revenue). This solution can be performed automatically, so a retailer is does not know the prices are shifting for the small-revenue products.

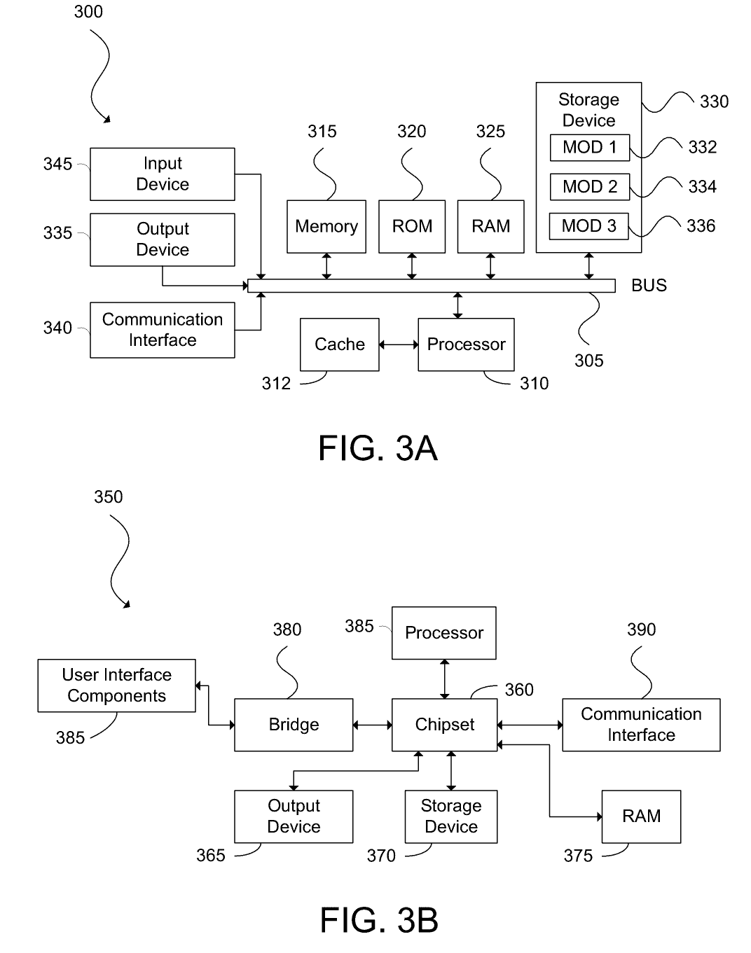

The products shown in FIG. 1A and FIG. 1B can be selectable. For example, a system (e.g., shown in FIGS. 3A and 3B) displaying a graphical user interface illustrated in FIGS. 1A and 1B can receive input for interaction with the products displayed (e.g., 102, 104, etc.). In some examples, a user can click on each product of the heat maps (e.g., 100, 150) and in response the system can display current price, the product description, identifier, current and recommended price, units, profit, revenue, and margin, along with the premium for the price zone. In some examples, a user can select multiple products for comparing and contrasting the product description, identifier, current and recommended price, units, profit, revenue, and margin, along with the premium for the price zone.

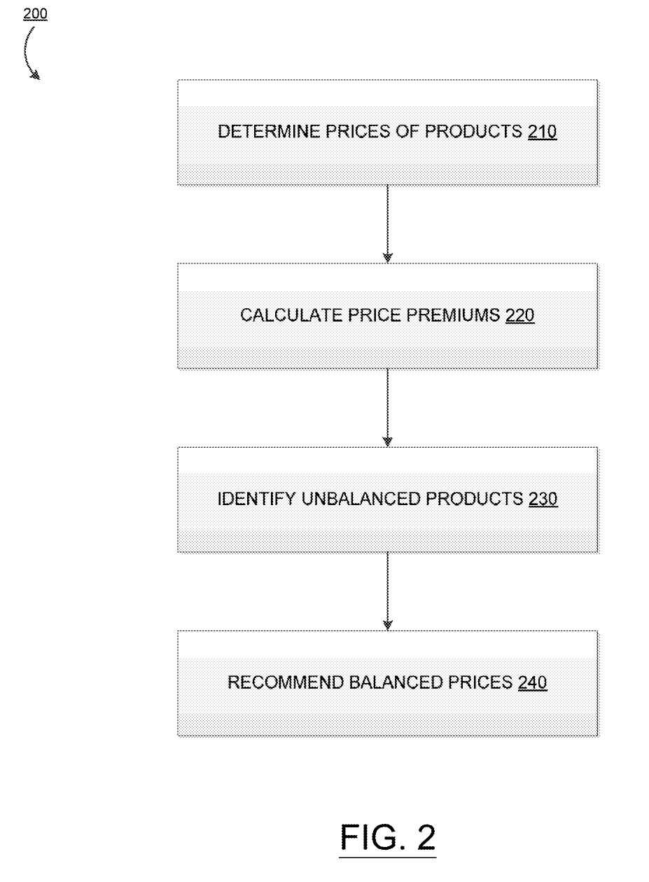

FIG. 2 illustrates an example method 200 for re-pricing products. The method shown in FIG. 2 is provided by way of example, as there are a variety of ways to carry out the method. Additionally, while the example method is illustrated with a particular order of blocks, those of ordinary skill in the art will appreciate that FIG. 2 and the blocks shown therein can be executed in any order that accomplishes the technical advantages of the present disclosure and can include fewer or more blocks than illustrated.

Each block shown in FIG. 2 represents one or more processes, methods or subroutines, carried out in the example method. The blocks shown in FIG. 2 can be implemented on devices illustrated in FIGS. 3A and 3B. The flow chart illustrated in FIG. 2 will be described in relation to and make reference to at the products, price zones, and charts of FIGS. 1A and 1B.

FIG. 2 illustrates an example method 200 for re-pricing products. By re-pricing products (e.g., balancing prices of products across price zones using logarithm-based least-squares fit), there can be an overall effect on profit margin of the products across the price zones. For example, when price outliers are mostly higher, then bringing them in line will cause an overall decrease in prices, and alternatively when price outliers are mostly lower, then bringing them in line will cause an overall rise in prices.

In some examples, retail chains might also want to maintain overall margin by a global-tuning adjustment. For example, prices of products can be raised or lowered by a constant factor. Along with, for example, price point restrictions (e.g., prices ending in the number nine, etc.) the global-tuning adjustment can be iterative to dial in the desired profit margin. Method 200 can begin at block 210. At block 210, the prices of products (e.g., 102, 104, 106, etc.) can be determined. For example, for each product (or a subset of products), a revenue-weighted average price of that product over all the price zones can be determined. In some examples, the revenue-weighted average price can be the total revenue at each price of a product.

At block 220, price premiums can be calculated. For example, price premiums can be the ratio of the product price in a price zones (e.g., 108, 110) divided by the revenue-weighed average price of the product. In some examples, price premiums are set by price zone to use for setting consistent prices across price zones. In some examples, the plurality of prices zones can be divided into subclasses (e.g., each subclass is a subset of the products in one or more price zones). The price premium of each subclass can be determined and then used to build a framework for the plurality of price zones. The price premiums can be a set of vectors αᵢ of price zone premiums for each subclass i or an enterprise vector a of price zone premiums.

For ease of explanation, a single subclass will be used as an example of calculating the price premiums. This is in no way limiting to the disclosure, and is one example on how to calculate the price premiums. In other examples, one or more, or a plurality of subclasses can be used.

A subclass can include a plurality of products and price zones, where each product is priced for each price zone where it is sold. The price premium can be the ratio of the product price in a price zone divided by the revenue-weighed average price of the product.

For each pair of price zones (e.g., for each product) the average logarithm of the price ratio weighted by the product of their revenues in the price zones can be determined. For example, for each pair (i,j), the logarithm of the price ratio of a product selling in both i and j can be determined. Since the price ratio ij is the reciprocal of the price ratio ji, the resulting matrix of weighted-average price ratios will be anti-symmetric, αᵢⱼ=−αᵢⱼ (ij pairs of price zones can have a product in common).

In some examples, not every product is sold in every price zone. For example, as shown in FIGS. 1A and 1B, white areas can illustrate products not sold in the respective price zones. As such, the set of price zones can be divided into subgraphs of price zones connected by chains of common products (e.g., a product selling in price zones i and j). Price zones (i,j) can be connected when they sell at least one product in common. For example, every pair of price zones sharing one or more products as being vertices connected by edges in a graph, then the price zone subgraphs are the connected subgraphs in the graph. In some examples, there can be products that are not sold across two or more price zones (e.g., a product my not be sold in different geographic locations—Asia and North America). When products are not sold across two or more price zones (i,j) the calculations can be handled separately.

For the price zones in the subgraph in the subclass, a least-squares fit of coefficients αₘ can be determined. For example, for each price zone m in the subgraph, the difference in coefficients to the difference in the product prices in the price zone can be matched. The least-squares fit of coefficients can be determined below using Equation (1). In Equation (1), LP is the natural logarithm of the price, R is revenue, m and n are price zones, and p is a product.

$$min S = {\sum }_{m}^{ } {\sum }_{n}^{ } {\sum }_{p}^{ } {R}_{pm} {{R}_{pn} ( ( {a}_{m} - {a}_{n} ) - ( {LP}_{pm} - {LP}_{pn} ) )}^{2} \qquad ( 1 )$$

Since the αₘ terms can change by a constant (without changing S), a constraint can be added. For example, a constraint can be added where the αₘ terms sum to zero within each price zone subgraph.

The vector a can be the solution to Ma=b, where Equation (2) is the matrix diagonal; Equation (3) is the matrix off-diagonal, and Equation (4) is vector b for price zone m.

$$\begin{matrix}{M}_{m , m} = {\sum }_{{n}_{\neq } m}^{ } {\sum }_{p}^{ } {R}_{pm} {R}_{pn} & ( 2 ) \\ {M}_{m , n} = {\sum }_{p}^{ } - {R}_{pm} {R}_{pn} & ( 3 ) \\ {b}_{m} = {\sum }_{{n}_{\neq } m}^{ } {\sum }_{p}^{ } {R}_{pm} {R}_{pn} ( {LP}_{pm} - {LP}_{pn} ) & ( 4 )\end{matrix}$$

However, matrix M is not enough to determine vector a. In some examples, a constraint, that is, a row (e.g., K) at the bottom and on the right can be added. For example, M_{K,m}=M_{m,K}=1, when m≠K, M_{K,K}=0, and b_{K}=0, so the sum of all αₘ=0.

Matrix M can easily inverted by well-known numerical algorithms (e.g., even with hundreds of price zones). It is usually well conditioned and the solution vector a is the result. The value of αₘ can be the average premium of price zone m.

In other examples, different solution models for αₘ can be used (i.e., besides linear-least-squared-error on the logarithms). For example, the ratio fit as shown in U.S. patent application Ser. No. 14/219,795, entitled “System and Method for Determining Retail-Business-Rule Co-efficient from Current Prices”.

The price zone premiums can be determined for the price zones selling products in the subclass. In some examples, the determined average price zone price premiums (e.g., vector αₘ) in a single subclass can be used to balance prices.

In some examples, more than one subclass can be used to determine the price premiums. For example, a unifying price premium for each price zone that spans the subsclasses can be determined by combining the individual-subclass results. The results can be combined by individual subclass-subgraph and not by aggregating all the subclass values and comparing them. For example, when two price zones both sell the same products in a subclass, then the comparison between the two price premiums for that subclass are meaningful (e.g., can be used in price balancing). In another example, when there is no chain of same-products links between two price zones in a subclass, then their calculated price premiums do not contain information about the relationship between those price zones, and are not meaningful for price balancing.

Price zones m and n can be connected by the total sub-class revenue products RₘRₙ, where they're in the same subgraph of the same subclass. This revenue value provided new, comprehensive network of price zones. These price zones can be divided into subgraphs of this new, comprehensive network, where price zones in the same subgraph are connected by chains of positive revenue products RₘRₙ.

When more than one subclass is used, the same determination as (as with one subclass) is used to minimize the least-sum-of-squared error of estimates of the logarithms of the price zone premiums.

At block 230, unbalanced products can be identified. For example, prices of products in price zones that are not inline with prices of other, similar products in the same price zone can be identified as unbalanced. This can be shown in products 102, 104, 106 of FIG. 1A. For example, an unbalanced product (or outlier) can be when the price-zone premium for the product is out of line (e.g., too high or too low) with the calculated-average price-zone premium. In some examples, the identification can be determined based on the prices of the products and the price premiums calculated in block 220.

At block 240, balanced prices can be recommended. For example, new prices for products that were identified as unbalanced can be recommended. There can be three stages of price recommendation, calculating prices, estimating benefit for the purpose of price zone balance, and tuning the profit-revenue tradeoff. In some examples, recommended price changes can be based on how far the product price premium for the price zone was from the calculated-average price premium for the price zone.

In some examples, the recommended balanced prices can be determined on a price zone basis. For example each price zone has a calculated premium where a standard deviation can be determined (e.g., from the product-price zone premiums). The standard deviation of the product premiums in the price zone can be determined from its own mean (i.e., usually not be the best fit calculated above) or from the computed value as if it were the mean. The balanced prices can be a proscribed multiple of that standard deviation (e.g., 1.0, less than 1.0 when price zones are to be kept in tighter alignment, etc.).

The benefits of balanced pricing of product's in price zones can also be determined. For example, to measure of the efficiency of the balanced prices. In some examples, a demand model based on elasticity linear in price can be used. If elasticity e is set to some constant β times price p, then a demand model can be shown in Equation (5).

D=Q₀e^{-βp} (5)

, where D is demand in unit sales and Q₀ is a constant value, essentially the amount shoppers would take home if products were free.

A framework can be based on this model where it is assumed balanced prices are optimal for the purpose of balancing price zone prices (but not for other aspects of retail-science planning). Given a pre-assigned ratio λ of revenue and profit, the value of a solution is Equation (6).

ν=λπ+(1−λ)R (6)

, where π is profit and R is revenue. The maximum value ν is achieved in Equation (7).

$$p = λ c + \frac{1}{β} \qquad ( 7 )$$

where c is cost. Therefor the optimum β value β* is Equation (8).

$${β}^{*} = \frac{1}{p - λ c} \qquad ( 8 )$$

where Q₀ can be based on actual units (of the products) sold and β*, and a price zone-balance benefit can be determined (based on this model). As such, the estimated benefit can be based on the assumption that price zone premiums should be balanced (a good idea in retail experience).

The method 200, can in some situations, provide an unbalanced benefit in revenue and profit (compared to the input prices). In some examples, it can be preferable to use a solution that benefits both revenue and profit substantially equally (on a percentage basis). In some examples, an equal benefit of revenue and profit can be determined by scaling the price zone premiums by a factor t to equalize the revenue and profit. In some examples, the scaling can be an increase or a decrease. Conversely, more profit than revenue gain lowers t to lower the price zone premiums, which lowers prices. Since t is not too far from 1.0, the steps of ΔT=0.1 up or down can be used (as needed). Once revenue and profit percentage benefits cross over, the step size ΔT can be reduced (e.g., to 0.01 and even 0.001) to evenly match the percentage increase of profit and revenue by this price zone-premium-balancing estimate.

While examples shown have been for balancing regular prices of products, the above methods can also balance promotional prices (on sale).

FIG. 3A and FIG. 3B show exemplary possible system embodiments. The more appropriate embodiment will be apparent to those of ordinary skill in the art when practicing the present technology. Persons of ordinary skill in the art will also readily appreciate that other system embodiments are possible.

FIG. 3A illustrates a conventional system bus computing system architecture 300 wherein the components of the system are in electrical communication with each other using a bus 305. Exemplary computing system 300 includes a processing unit (CPU or processor) 310 and a system bus 305 that couples various system components including the system memory 315, such as read only memory (ROM) 320 and random access memory (RAM) 325, to the processor 310. The system 300 can include a cache of high-speed memory connected directly with, in close proximity to, or integrated as part of the processor 310. The system 300 can copy data from the memory 315 and/or the storage device 330 to the cache 312 for quick access by the processor 310. In this way, the cache can provide a performance boost that avoids processor 310 delays while waiting for data. These and other modules can control or be configured to control the processor 310 to perform various actions. Other system memory 315 may be available for use as well. The memory 315 can include multiple different types of memory with different performance characteristics. The processor 310 can include any general purpose processor and a hardware module or software module, such as module 1 332, module 2 334, and module 3 336 stored in storage device 330, configured to control the processor 310 as well as a special-purpose processor where software instructions are incorporated into the actual processor design. The processor 310 may essentially be a completely self-contained computing system, containing multiple cores or processors, a bus, memory controller, cache, etc. A multi-core processor may be symmetric or asymmetric.

To enable user interaction with the computing system 300, an input device 345 can represent any number of input mechanisms, such as a microphone for speech, a touch-sensitive screen for gesture or graphical input, keyboard, mouse, motion input, speech and so forth. An output device 335 can also be one or more of a number of output mechanisms known to those of skill in the art. In some instances, multimodal systems can enable a user to provide multiple types of input to communicate with the computing system 300. The communications interface 340 can generally govern and manage the user input and system output. There is no restriction on operating on any particular hardware arrangement and therefore the basic features here may easily be substituted for improved hardware or firmware arrangements as they are developed.

Storage device 330 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 325, read only memory (ROM) 320, and hybrids thereof.

The storage device 330 can include software modules 332, 334, 336 for controlling the processor 310. Other hardware or software modules are contemplated. The storage device 330 can be connected to the system bus 305. In one aspect, a hardware module that performs a particular function can include the software component stored in a computer-readable medium in connection with the necessary hardware components, such as the processor 310, bus 305, display 335, and so forth, to carry out the function.

FIG. 3B illustrates a computer system 350 having a chipset architecture that can be used in executing the described method and generating and displaying a graphical user interface (GUI). Computer system 350 is an example of computer hardware, software, and firmware that can be used to implement the disclosed technology. System 350 can include a processor 355, representative of any number of physically and/or logically distinct resources capable of executing software, firmware, and hardware configured to perform identified computations. Processor 355 can communicate with a chipset 360 that can control input to and output from processor 355. In this example, chipset 360 outputs information to output 365, such as a display, and can read and write information to storage device 370, which can include magnetic media, and solid state media, for example. Chipset 360 can also read data from and write data to RAM 375. A bridge 380 for interfacing with a variety of user interface components 385 can be provided for interfacing with chipset 360. Such user interface components 385 can include a keyboard, a microphone, touch detection and processing circuitry, a pointing device, such as a mouse, and so on. In general, inputs to system 350 can come from any of a variety of sources, machine generated and/or human generated.

Chipset 360 can also interface with one or more communication interfaces 390 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 355 analyzing data stored in storage 370 or 375. Further, the machine can receive inputs from a user via user interface components 385 and execute appropriate functions, such as browsing functions by interpreting these inputs using processor 355.

It can be appreciated that exemplary systems 300 and 350 can have more than one processor 310 or be part of a group or cluster of computing devices networked together to provide greater processing capability.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

A “server” can be any physical or virtual computer systems running one or more services or applications, to serve the requests of other computers or electronic devices on a communications network. Such servers can include, but are not limited to: application servers, cloud servers, web servers, database servers, file servers, communications servers, proxy servers, name servers, home servers, fax servers, mail servers, print servers, game servers, routers, switches, or any other type of suitable server. An application server can be dedicated to running certain software applications. The physical server can be a rack server, tower server, miniature server, home server, mini rack server, blade server, or any other type of server. A cloud server can be computing resources are dynamically provisioned and allocated on-demand from a collection of resources available via the network (e.g., “the cloud”). Cloud computing resources can include any type of resource such as computing, storage, network devices, virtual machines (VMs), etc. The server can have the following hardware, one or more central processing units (CPU), one or more of a memory, one or more of a power supply, one or more of a bus, one or more of a network module (such as, LAN module, Ethernet module, Wireless Fidelity module (Wi-Fi), location module (GPS)), one or more of a cooling system (such as, air conditioning, ventilations, fan system). The server can run the following Operating System (OS) software, Windows, UNIX, Linux, OSX, or any other suitable Operating System. The server can also run one or more server software programs, depending on the type of server, such as, application software (Java™, .NET Framework™, or software specific to the application begin hosted on the server), web server software (Apache™ or Internet Information Services IIS™), database software applications (Oracle MySQL™, Sybase™, or any other database software), or any other type of server software programs.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

We claim:

1. A method for balancing prices, the method comprising:
determining, at a server, one or more prices of one or more products across one or more price zones;
calculating, at the server, price premiums between the one or more price zones for the one or more products;
identifying, at the server, one or more unbalanced prices of the one or more products; and
recommending, from the server, one or more balanced prices for the one or more unbalanced prices of products.

2. The method of claim 1, wherein the determining further comprising:
determining for each of the one or more products a revenue-weighted average price over the one or more price zones.

3. The method of claim 2, wherein the calculating further comprising:
determining a ratio for each of the one or more prices of each of the one or more products across each of the one or more price zones by dividing each price by the revenue-weighted average price of the product.

4. The method of claim 1, wherein the price premiums are calculated using least-square fit.

5. The method of claim 1, wherein the identifying further comprising:
comparing each of the one or more prices of the one or more products across the one or more price zones with the price premiums; and
when a price of the one or more prices is outside of a prescribed threshold of the price premiums, determining the product associated with the price is unbalanced.

6. The method of claim 1, wherein the one or more balanced prices increases an unbalanced price of the one or more products.

7. The method of claim 1, wherein the one or more balanced prices decreases an unbalanced price of the one or more products.

8. A system for balancing prices, the system comprising:
a processor; and
a memory storing instructions which when executed by the processor, cause the processor to:
determine one or more prices of one or more products across one or more price zones;
calculate price premiums between the one or more price zones for the one or more products;
identify one or more unbalanced prices of the one or more products; and
recommend one or more balanced prices for the one or more unbalanced prices of products.

9. The system of claim 1, wherein the determination further comprising:
determine for each of the one or more products a revenue-weighted average price over the one or more price zones.

10. The system of claim 9, wherein the calculation further comprising:
determine a ratio for each of the one or more prices of each of the one or more products across each of the one or more price zones by dividing each price by the revenue-weighted average price of the product.

11. The system of claim 8, wherein the price premiums are calculated using least-square fit.

12. The system of claim 8, wherein the identification further comprising:
compare each of the one or more prices of the one or more products across the one or more price zones with the price premiums; and
when a price of the one or more prices is outside of a prescribed threshold of the price premiums, determine the product associated with the price is unbalanced.

13. The system of claim 8, wherein the one or more balanced prices increases an unbalanced price of the one or more products.

14. The system of claim 8, wherein the one or more balanced prices decreases an unbalanced price of the one or more products.

15. A non-transitory computer readable medium, storing instructions which when executed by a processor cause the processor to:
determine one or more prices of one or more products across one or more price zones;
calculate price premiums between the one or more price zones for the one or more products;
identify one or more unbalanced prices of the one or more products; and
recommend one or more balanced prices for the one or more unbalanced prices of products.

16. The non-transitory computer readable medium of claim 15, wherein the determination further comprising:
determine for each of the one or more products a revenue-weighted average price over the one or more price zones.

17. The non-transitory computer readable medium of claim 16, wherein the calculation further comprising:
determine a ratio for each of the one or more prices of each of the one or more products across each of the one or more price zones by dividing each price by the revenue-weighted average price of the product.

18. The non-transitory computer readable medium of claim 15, wherein the identification further comprising:
compare each of the one or more prices of the one or more products across the one or more price zones with the price premiums; and
when a price of the one or more prices is outside of a prescribed threshold of the price premiums, determine the product associated with the price is unbalanced.

19. The non-transitory computer readable medium of claim 15, wherein the one or more balanced prices increases an unbalanced price of the one or more products.

20. The non-transitory computer readable medium of claim 15, wherein the one or more balanced prices decreases an unbalanced price of the one or more products.
